(19) United States
(12) Patent Application Publication
(10) Pub. No.: US 2017/0056852 A1
(43) Pub. Date: Mar. 2, 2017

(54) DEVICE FOR CONTINUOUSLY FEEDING DIVIDED SOLIDS TO A PRESSURISED PROCESS OR FOR CONTINUOUSLY EXTRACTING DIVIDED SOLIDS FROM SAID PROCESS

(71) Applicant: COMMISSARIAT A L'ENERGIE ATOMIQUE ET AUX ENERGIES AL TERNATIVES, Paris (FR)

(72) Inventors: Jean Christophe RUIZ, Laudun L'ardoise (FR); Hubert-Alexandre TURC, Les Angles (FR); Frederic CHARTON, Bagnols Sur Ceze (FR)

(73) Assignee: COMMISSARIAT A L'ENERGIE ATOMIQUE ET AUX ENERGIES AL TERNATIVES, Paris (FR)

(21) Appl. No.: 15/307,680

(22) PCT Filed: May 5, 2015
(86) PCT No.: PCT/EP2015/059783

§ 371 Date: Oct. 28, 2016

(30) Foreign Application Priority Data
May 7, 2014 (FR) 14 54135

(51) Int. Cl. B01J 8/00

(52) U.S. Cl. CPC B01J 8/002; B01J 2208/00769; B01J 2208/00787

(57) ABSTRACT

The invention relates to a device for continuously incorporating solids into a pressurised fluid which is either liquid or gaseous, comprising a string of pistons sliding inside a tube in order to define therein hermetically separated chambers, which tube is brought to increasing and then decreasing pressures by feeding and venting fluid. The solids are incorporated into the fluid at the inlet of the tube. In the centre of the tube, there are connections to a circuit in which the fluid flows and which feeds the solids towards a reactor where said solids are treated. This arrangement also makes it possible for divided solid materials to be extracted from the reactor, such that said solid materials are continuously depressurised.

The subject of the present invention is a device for continuously feeding divided solids to a pressurised process or for continuously extracting divided solids from said process.

It can be applied to treatment methods under pressure or even very high pressure that may for example relate to the treatment of waste by hydrothermal method, the production of materials or the decontamination of materials, the fluid of the method being able to be liquid or gaseous. The dimensions of the divided solids are not critical for the method of the invention, but several industrial methods considered here have recourse to solids of millimetric size. In the application of the waste treatment methods, the solids may be reduced to sizes that are appreciably submillimetric, or even eliminated. Finally, the solids may be dry originally, or on the contrary already mixed with a fluid, which is then at low pressure.

A fluid is conventionally pressurised by means of pumps, but divided solids are liable to damage them or make them unusable, by erosion, abrasion or clogging, and the most robust pumps in regard to these phenomena are often those that do not allow the greatest pressure rises. It is therefore difficult to find pumps suitable for the continuous pressurisation of solids divided in suspension in a fluid medium to high pressures, despite the large number of models available; many pumps must even work with pure fluids, the solids that they may contain being stopped by inlet filters. It can be mentioned in particular that the pressure is in general maintained by non-return valves, which are driven in alternating movements, but are very sensitive to scratching produced by solid bodies.

The non-pumpable fluid/solid mixtures that have to be pressurised must then be treated in discontinuous mode by batches, which leads to inadequate technical and economic optimisation, the reactors where the treatment is performed being subject to cycles comprising stop phases and then re-establishment of operating conditions between each batch, which is fairly expensive in terms of time, energy and efficiency in industrial processes. On the laboratory scale, these drawbacks of implementing reactions of interest in discontinuous (batch) methods are less serious, but the results are difficult to extrapolate in many cases, for example in studies of synthesis, reaction or degradation of materials, when the duration of the reduction cycles involves times significantly greater than the duration of the phenomena observed during the pressure maintenance.

The present invention relates a device for supplying a pressurised fluid with divided solids, which is compatible with continuous treatment of the loaded fluid. The divided solids may be added in the dry state (dry or moist biomass, mineral particles, etc.), or already present in a particular fluid such as a liquid (mineral fillers, organic fibres, etc.). The treatment method may be at several hundred bar. The continuity of the method makes it possible to economise on energy, while avoiding having recourse to resumptions and stoppages of periodic cycles. When the treatment makes it possible to recover mechanical energy, part thereof may be devoted to the maintenance of the movement of the device of the invention, which improves the continuity of the process. The design of the device may be adapted between laboratory size and industrial size.

The present invention also makes it possible to continuously collect and depressurise solid particles coming from the pressurised method according to the same principle of implementation as the supply that is essentially described in this document. These particles may for example be materials produced in the method under upstream pressure, which is the case of a synthesis method; they may be untreated organic matter residues in the case of hydrothermal gasification methods, non-reprocessible mineral material in the case of hydrothermal lixiviation, non-resolubilised mineral precipitates in the case of hydrothermal oxidation methods. The solids may be of submillimetric or millimetric size, or greater. One general advantage of the device is that it is simple and inexpensive; it may also be integrated easily in pressurised reactors.

In a general form, the invention relates to a device for continuously feeding or extracting a pressurised fluid containing divided solids, comprising a tube, a string of pistons, connected together by a chain and sliding in the tube sealingly, the tube comprising fluid feeds distributed from an inlet of the tube to a central portion of the tube and staged at increasing pressures towards the central portion, a feed of the divided solids in suspension or not in a fluid, compressible or not, at the inlet of the tube, and a circuit for flow of the pressurised fluid, the flow circuit passing through the tube to the central portion, emerging therein through a flow feed and a flow discharge communicating with each other when the string of pistons is present in the tube, the flow discharge also being a discharge of the divided solids.

The main technical effect achieved is that the fluid injected into the tube and receiving the divided solids is separated into a plurality of chambers delimited by the pistons, which are subjected to successive pressure rises through the additional feeds, as the fluid is advanced towards the centre of the tube. At this point, the flow of the treatment fluid already under pressure passes through the tube and entrains the solid particles with it. At the discharge from the tube, there remains only pure fluid, which is reduced in pressure while continuing to advance, and can then be discharged and recycled.

The various aspects, features and advantages of the invention will now be described in detail by means of the following figures:

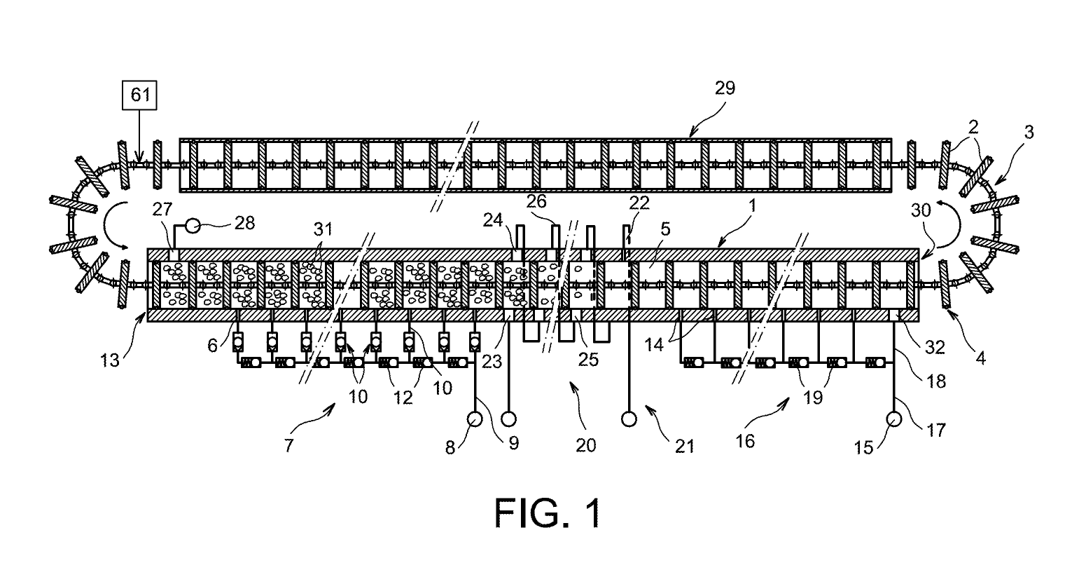

FIG. 1 is a view of a first embodiment of the invention;

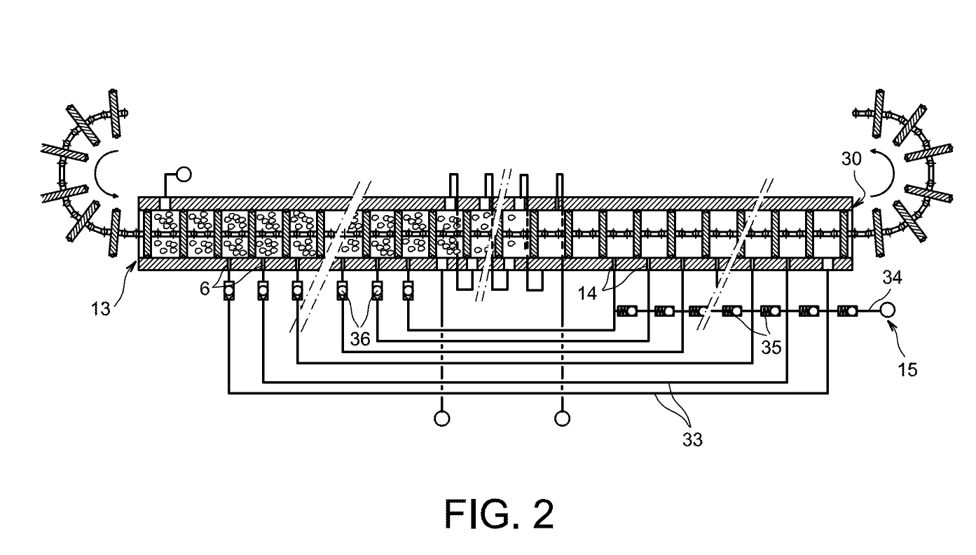

FIG. 2, a view of a second embodiment of the invention; and

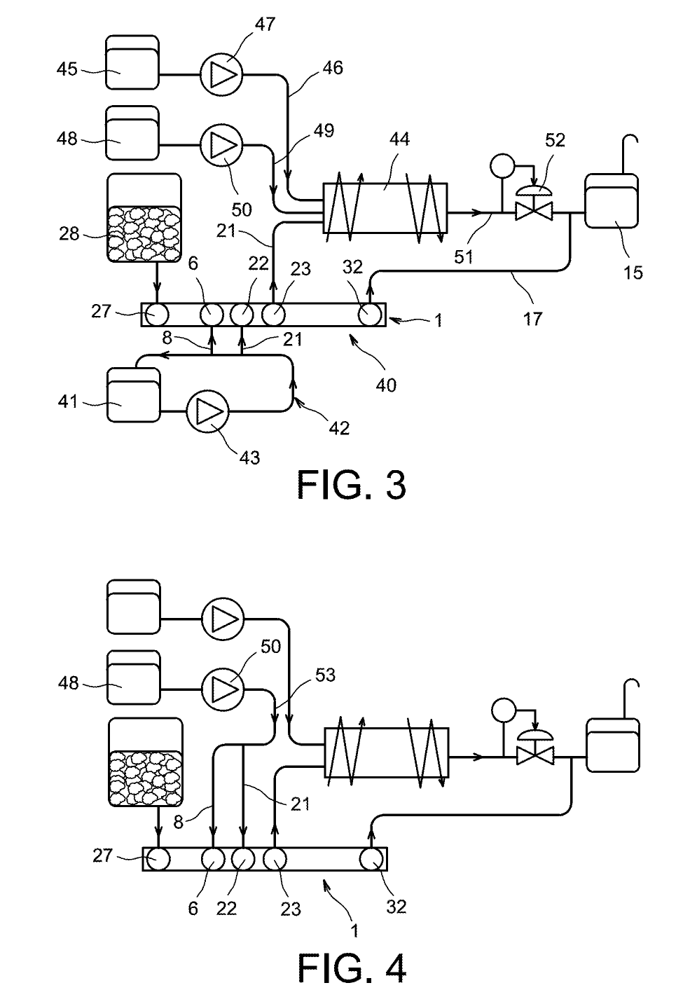

FIGS. 3, 4, 5 and 6 illustrate various devices applying the invention, for continuous methods.

The device in FIG. 1 comprises a rectilinear tube 1 and a string of pistons 2 attached at a uniform pitch to a chain 3 in an endless loop passing through the tube 1. The diameter of the pistons 2 is chosen so as to be a little less than the bore of the tube 1 in order to enable them to slide therein. The edge of the pistons 2 carries a simple sealing system with a seal 4 rubbing against the internal wall of the tube 1 and creating a dynamic seal inside the tube. The sealing sought is both static since it is based on a physical barrier (contact between the pistons 2, the seals 4 and the bore of the tube 1) and dynamic since it is maintained despite the sliding of the pistons 2 in the bore of the tube 1 and the rubbing of the seals 4 on the bore. A sealed chamber 5 is thus established in the tube 1 between each pair of consecutive pistons 2. This device aims to gradually increase the pressure in each chamber 5 from the feed pressure to the operating pressure, by the controlled injection of fluid via tappings 6. It also aims to gradually depressurise each chamber 5 through the vents 14 from the feed pressure to the discharge pressure.

Hereinafter, one embodiment is proposed. The seal 4 may be a simple seal such as an O-ring seal, which is made possible by the essential feature of the invention that a high-pressure seal is obtained by a succession of differential low-pressure seals.

The device also comprises a certain number of fluid-feed tappings 6, which are the ends of a fluid-distribution network 7, joining the feed tappings 6 to a high-pressure fluid feed 8. The distribution network 7 comprises a main duct 9, starting from the pressurised fluid feed 8, and branches 10 parallel to one another and each connecting the main duct 9 to one of the feed tappings 6. The branches 10 are each provided with a non-return valve 11, which prevents flow of fluid to the main duct 9; and the main duct 9 is provided with calibrated valves 12, which are pressure reducers successively reducing the pressure of the fluid, in a staged fashion, as it advances in the main duct 9. One of the calibrated valves 12 is established between each pair of branches 10 so that the pressures of the fluid passing through the branches 10 are all different, and more precisely decreasing for tappings 6 closer to an inlet 13 of the tube 1, through which the pistons 2 enter during the operation of the apparatus.

Vent tappings 14 are disposed through the tube 1 at a region remote from the inlet 13, and serve as an outlet for the fluid. They end up in a receiver 15 for recovering fluid, at low pressure or atmospheric pressure, and are connected thereto by a discharge network 16 which, like the previous one, comprises a main duct 17, provided with branches 18 that connect it respectively to the vent tappings 14. Likewise, calibrated valves 19 extend on the main duct 17, between each pair of branches 18. The calibrated valves 19 are pressure reducers that make it possible to reduce successively and in a staged fashion the pressure of the fluid towards the receiver 15, with the consequence that the fluid can flow through the vent tappings 14 at different pressures, and more precisely decreasing towards an outlet 30 of the tube 1, which is opposite to the inlet 13. The feed 6 and vent 14 tappings are staged at regular and equal distances, and the pistons 2 are remote from each other by the same distances on the chain 3, which means that only one of the tappings 6 and 14 emerges in each of the chambers 5.

The tube 1 comprises a central portion 20, where the feed 6 and vent 14 tappings are absent. Connections are however found to a circuit 21 for the flow of fluid, which enters the tube 1 through a flow-feed tapping 22 and emerges therefrom through a flow-discharge tapping 23, closer to the inlet 13; top tappings 24 and bottom tappings 25 are provided between them, each of the top tappings 24 being connected to a respective bottom tapping 25, through a pipe 26, which provides a bypass circulation for the fluid alongside the tube 1. Finally, the tube 1 also comprises a tapping 27 for feeding solid products, disposed close to the inlet 13, and which is connected to a reservoir 28 for solid products. The latter tapping 27 is shown at the top of the tube 1, in order to use gravity for supplying the appliance with solid products, but no position or orientation of the tappings on the tube is necessary, the solid products being able to be injected into the tube 1 by pumping or suction, whether they be dry or present originally in a liquid.

The device also comprises a guide tube 29, parallel to the main tube 1, and intended to keep the train of pistons 2 out of the tube 1.

The functioning of the device will now be described. Pumps put the feed fluid 8 under pressure and initiate a circulation, also under pressure, of the fluid in the flow circuit 21, with pressurised feed characteristics making it possible to maintain the flow even if fluid is taken off in each chamber 5 in order to maintain its pressure. A motive driving device 61 moves the chain 3 and the pistons 2, causing them to travel through the inside of the tube 1 from the inlet 13 to the outlet 30. The pistons 2 present in the tube 1 therefore divide its internal volume into consecutive chambers 5, hermetically separated. The chambers 5 first of all pass under the tapping feeding solid products 27 and are supplied with the solid products 31 in the divided state. They next pass successively through each of the feed tappings 6 and therefore receive the fluid coming from the feed 8, at ever greater pressures, due to the action of the calibrated valves 12. The spacing of the feed tappings 6, like moreover that if the vent tappings 14, is approximately equal to the length of the chambers 5, so that each of them gives onto a single tapping 6 or 14.

The chambers 5 are therefore filled with a mixture of fluid at a maximum pressure, close to that of the pressure at the feed 8, and divided solids 31, leaving the distribution network 7. They then arrive at the flow circuit 23, the fluid of which is raised to a high pressure similar or close to that of the feed 8. At this central portion 20 of the tube 1, each of the chambers 5 is in communication with two tappings: a tapping 24 or the flow-feed tapping 22 on the one hand, and a tapping 25 or the flow-discharge tapping 23 on the other hand. These two tappings of each of the chambers 5 are opposing. With this arrangement, the flow of fluid forms a transverse current in each of the chambers 5 concerned, passing through the bypass pipes 26. The main consequence of the currents that the flow forms through the chambers 5 to the inlet 13 is that the solid products 31 are discharged in the tube 1 and the bypass pipes 26, and then in the flow-discharge tapping 23, where they are incorporated in the flow of fluid allowing a reverse-flow washing of the chambers 5 at the same time as the transfer of the fluid isobarically. The chambers 5 that go beyond the flow-feed tapping 22 are normally devoid of solid products 31 filled with fluid. Arriving at the vent tappings 14, the pressure in the chambers 5 drops in stages, as far as a final tapping, bearing the reference 32, which allows drainage of the chambers 5, complete return of the fluid to the receiver 15 and the implementation of depressurisation.

This functioning therefore makes it possible to incorporate the divided solids 31 without difficulty in a pressurised fluid and to treat them continuously while avoiding the implementation of a single dynamic sealing that has to withstand a high pressure gradient.

A variant design is depicted in FIG. 2. The networks 7 and 16 are omitted as is the fluid feed 8. The feed tappings 6 are each connected to one of the vent tappings 14 by a self-contained duct 33 in an arrangement where the tappings 6 close to the inlet 13 are connected to tappings 14 similarly close to the outlet 30. The ducts 33 are however connected together by a common duct 34 which leads to the receiver 15; calibrated valves 35 are disposed on the common duct 34 between each pair of ducts 33.

In arriving at each of the vent tappings 14, the chambers 5 as before lose part of their pressure through a flow in the corresponding duct 33, according to the settings of the calibrated valves 35. The residual pressure is communicated to the chamber 5, on the inlet 13 side, served by this same duct 33. Non-return valves 36 are provided on the ducts 33 in order to avoid pressure losses in these chambers 5, close to the inlet 13. The rest of the device is unchanged. This variant embodiment is practicable with a sufficient fluid feed in the chambers 5 close to the inlet 13, for example at the same time as the solid products 31. In these two variant embodiments, the tube 1 can be surrounded by heat exchangers, not shown, if it is necessary to heat or cool the compressed and then expanded fluid: such an arrangement may have an advantage in certain methods where isothermal conditions must be complied with, such as in certain methods where the fluid is gaseous.

The device provides the pressurisation of the fluid by having recourse solely to small regular movements of the pistons 2, which cause little abrasion and wear on the tube 1 and seals 4 by the solid products 31. The static equilibrium of the chain 3 carrying pistons 2 is also maintained, which makes it possible to move it with little force.

Reference is made to the following FIGS. 3 to 6 to discover certain diagrams for integration of the device of the invention, bearing the reference 40, in apparatus designed for industrial methods.

In the embodiment in FIG. 3, the fluid used for putting the solid products 31 in suspension is first of all contained in a reservoir 41, and moved in a loop duct 42 by a pump 43; the feed 8 and the flow circuit 21 are branches of the loop duct 42. The flow circuit 21 ends at a reactor 44, able to conduct a continuous reaction. It is also supplied with a reactive fluid, originally contained in a reservoir 45, through a duct 46 provided with a pump 47, and with a pressurisation-maintenance fluid, which is likewise originally contained in a reservoir 48, through a duct 49, provided with a pump 50. A plurality of reactive fluids may be present and fed in the same way. The reactor 44 is provided with an effluent duct 51, which ends at the receiver 15 like the main duct 17 of the discharge network 16. An outlet 52 is established on the effluent duct 51 so as to open only when the pressure required in the reactor 44 is reached.

In the embodiment in FIG. 4, the loop duct 42 is omitted, and the entrainment of the solid products 31 is provided by one of the fluids acting directly in the method, for example the fluid forming the pressurised medium. The reservoir 48 is then provided with a different outlet, in the form of a duct 53, which replaces the duct 49 and ends at the feed 8 and at the flow circuit 21. The fluid therefore reaches the reactor 44 by means of the tube 1.

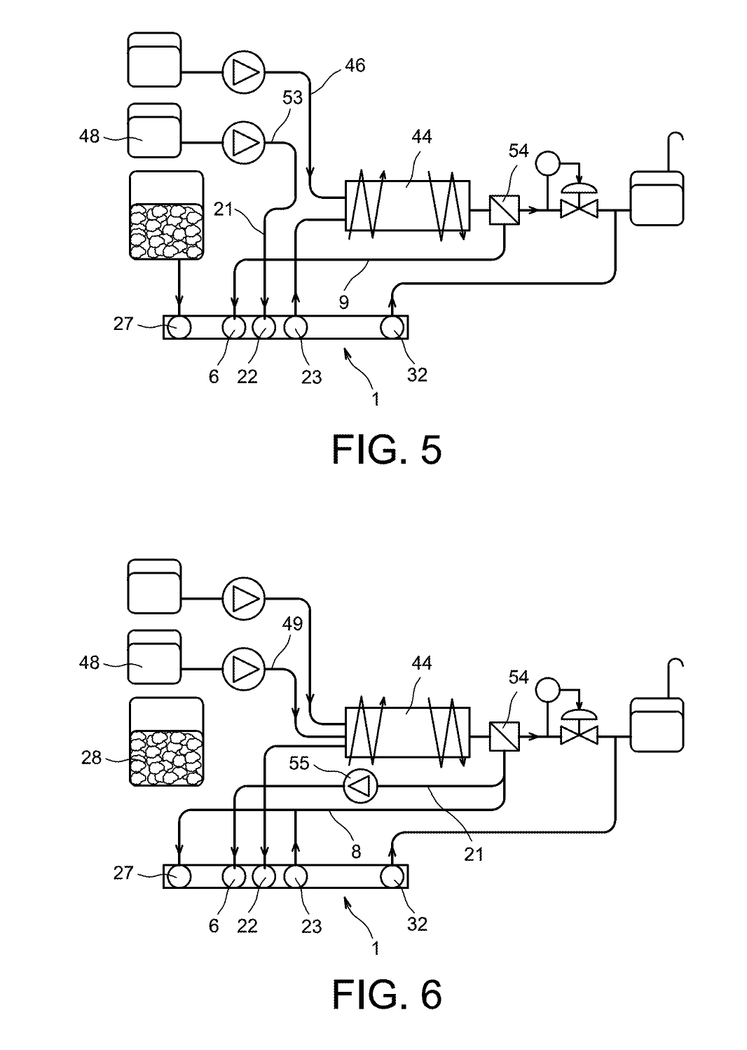

In the embodiment in FIG. 5, the duct 53 constitutes only the start of the flow circuit 21, and part of the effluent in the method is recycled in order to serve for the fluid feed 8: a separator 54 between the liquids and solids is for this purpose disposed on the effluent duct 51 downstream of the reactor 44, and diverts some of the liquid effluent to the feed tappings 6 through the main duct 9.

The embodiment in FIG. 6 resembles that of FIG. 3 in that the reservoir 48 has its contents reaching the reactor 44 by means of the duct 49. The separator 54 of the embodiment in FIG. 5 is found again, the outlet duct of which also comprises the flow circuit 21, driven by a pump 55.

Among the possible applications of the invention, the following can be cited:
methods involving lixiviation or impregnation of divided solids, for example in supercritical CO₂;
methods involving pressurised cleaning of divided solids, for example also in supercritical CO₂;
methods involving a pressurised reaction of organic precursors for the synthesis of materials in supercritical CO₂ or supercritical water;
methods involving a pressurised reaction of natural or artificial solid raw materials in the case for example of the treatment of ion exchange resins (liquefaction or gasification in subcritical or supercritical water, destruction of solid waste by hydrothermal oxidation in subcritical or supercritical water);
the surface deposition, for example on macroporous monoliths, of divided solids of material produced under pressure, for example in supercritical water or supercritical CO₂, such as the manufacture and shaping of catalysts in one step.

The mechanical energy of the effluents may be recovered in whole or in part in order to help to reduce the expenditure of energy necessary for the feed of the method.

1-10 (canceled)

11. A device for continuously feeding or extracting a pressurised fluid containing divided solids, comprising a tube, a string of pistons, connected together by a chain and sliding in the tube sealingly, the tube comprising fluid feeds distributed from an inlet of the tube to a central portion of the tube and staged at increasing pressures towards the central portion, vents for the fluid distributed from the central portion of the tube to an outlet of the tube, opposite to the inlet, and staged at decreasing pressures towards the outlet, a feed of the divided solids at the inlet of the tube, and a circuit for flow of the pressurised fluid, the flow circuit passing through the tube to the central portion, emerging therein through a flow feed and a flow discharge communicating with each other when the string of pistons is present in the tube, the flow discharge also comprising a discharge of the divided solids.

12. The device for feeding or drawing off a pressurised fluid containing divided solids according to claim 11, wherein the feeds for the fluid form part of branches of a fluid-distribution network leading to a source of the pressurised fluid and provided with pressure reducers calibrated at different pressures.

13. The device for feeding or drawing off a pressurised fluid containing divided solids according to claim 12, wherein the pressure reducers are disposed in series on the same duct of the fluid-distribution network, and the branches are connected to the duct between the pressure reducers.

14. The device for feeding or drawing off a fluid containing divided solids according to claim 11, wherein the tube comprises vents for the fluid distributed from the central portion of the tube to an outlet of the tube, opposite to the inlet, and staged at decreasing pressures towards the outlet.

15. The device for feeding or drawing off a pressurised fluid containing divided solids according to claim 14, wherein the vents for the fluids form part of branches of a network for discharging the fluid leading to a receiver for the low-pressure fluid and provided with pressure reducers calibrated at different pressures.

16. The device for feeding or drawing off a pressurised fluid containing divided solids according to claim 15, wherein the pressure reducers are disposed in series on the same duct in the fluid-discharge network, and the branches are connected to the duct between the pressure reducers.

17. The device for feeding or drawing off a pressurised fluid containing divided solids according to claim 14, wherein the feeds for the fluid communicate respectively with the vents for the fluid.

18. The device for feeding or drawing off a pressurised fluid containing divided solids according to claim 11, wherein the chain is arranged in an endless loop, and the pistons are distributed at a uniform pitch along the chain.

19. The device for feeding or drawing off a pressurised fluid containing divided solids according to claim 11, wherein the tube is provided with successive bypass pipes between the flow feed and the flow discharge.

20. The device for feeding or drawing off a pressurised fluid containing divided solids according to claim 11, wherein the feeds for the fluid and/or the vents for the fluid are disposed at regular distances along the tube, and the pistons are distant by the same regular distances along the chain.
